(19) United States
(12) Patent Application Publication
(10) Pub. No.: US 2025/0381829 A1
(43) Pub. Date: Dec. 18, 2025

(54) Electrically Operated Motor Vehicle Having a Drive Battery in a Region of an Underbody of the Motor vehicle

(71) Applicant: Bayerische Motoren Werke Aktiengesellschaft, Muenchen (DE)

(72) Inventors: Manuel RIEDL, Weil (DE); Felix SCHUMACHER, Muenchen (DE); David WOEHRLE, Muenchen (DE)

(21) Appl. No.: 18/866,605

(22) PCT Filed: Jun. 27, 2023
(86) PCT No.: PCT/EP2023/067460

§ 371 Date: Nov. 18, 2024

(30) Foreign Application Priority Data
Jul. 15, 2022 (DE) 10 2022 117 785.8

(51) Int. Cl. B60K 1/04; B60L 50/60

(52) U.S. Cl. CPC B60K 1/04; B60L 50/66; B60K 2001/0438

(57) ABSTRACT

An electrically operated motor vehicle has a drive battery in a region of an underbody of the motor vehicle. The drive battery is mounted on a rear drive battery fastening region together with a left torsion bar and a right torsion bar on a left rear longitudinal support and a right rear longitudinal support, respectively, in particular in each case by way of a screw connection.

### BACKGROUND AND SUMMARY

The invention relates to an electrically operated motor vehicle having a drive battery in a region of an underbody of the motor vehicle.

A motor vehicle with an energy store is known from DE 10 2016 212 297 A1, which energy store is arranged on the floor of a vehicle body. V-shaped stiffening struts are arranged on a vehicle rear end. The stiffening struts are connected in a front region to a frame of the energy store. The stiffening struts are moreover connected in a rear region, via a bracket, to a cross member which is connected in turn to rear side members.

The object of the present invention is to provide an electrically operated motor vehicle having a drive battery in a region of an underbody, wherein assembly of the motor vehicle is simplified with simultaneous sufficient stiffness of the motor vehicle.

This object is achieved by an electrically operated motor vehicle having a drive battery in a region of an underbody having the features of the independent claim(s).

According to the invention, an electrically operated motor vehicle has a drive battery in a region of an underbody of the motor vehicle. The drive battery is assembled at a rear drive battery fastening region together, i.e. jointly, with a left torsion strut and a right torsion strut on a left rear side member and on a right rear side member.

Manufacturing of the motor vehicle is simplified by the joint assembly of the torsion struts on the respective rear side members. Likewise, design of the motor vehicle is simplified hereby.

The motor vehicle is preferably a passenger car, in particular with a front end, a rear end, and a passenger compartment between the front end and the rear end. The motor vehicle can be a vehicle operated by electricity alone or can also additionally have a different drive, such as for example an internal combustion engine, or a fuel cell for generating electrical energy.

The left torsion strut is advantageously connected, with a single screwed connection at the drive battery fastening region, together with the drive battery to the left rear side member, and the right torsion strut is connected, with a single screwed connection at the drive battery fastening region, together with the drive battery to the right rear side member.

The rear side member can be a rear-end side member which runs in particular as far as above a rear axle of the motor vehicle, or be a side sill of the motor vehicle.

The drive battery is preferably attached to an underside of the body floor, wherein the drive battery is arranged below a passenger compartment of the motor vehicle between side sills and a front end and a rear end of the motor vehicle. The drive battery can extend essentially over the entire width of the underbody.

According to a preferred development, the left torsion strut and the right torsion strut are in each case connected to a rear-axle support of the motor vehicle.

Stiffness of a rear end of the motor vehicle is further improved as a result.

The left torsion strut and the right torsion strut are preferably connected indirectly or directly to a left, in particular front, body fastening section and a right, in particular front, body fastening section of the rear-axle support.

The attachment to the front body fastening section of the rear axle support is particularly stiff.

The left torsion strut and the right torsion strut are advantageously connected to the body fastening section of the rear-axle support via a left additional support element and a right additional support element which are formed, for example, from a profiled piece of sheet metal or a casting. The additional support element acts in particular essentially as a compression strut and runs, for example, transversely to the respective associated torsion strut.

There is consequently no need that the torsion struts intersect with an attachment point to the body fastening section of the rear-axle support.

According to a preferred development, the left torsion strut and the right torsion strut run rearward toward each other, in particular in a V-shape. Furthermore, the torsion struts are connected to each other at an actual or virtual point of intersection of the torsion struts. The torsion struts are designed as straight in particular in their longitudinal extent, i.e. are not bent, curved, or the like.

The torsion struts are preferably connected to each other in an actual or virtual point of intersection of the two struts below the rear-axle support. Moreover, further torsion struts are attached in the region of an actual or virtual point of intersection and connected to the rear end or the rear-axle support.

The torsion struts preferably have an open profile, in particular consist of a single-shell profiled piece of sheet metal or an extruded profile. Alternatively or additionally, the torsion struts have a closed hollow profile, in particular consist of a two-shell piece of sheet metal or an extruded profile.

At least one front end section of the torsion struts advantageously has an open profile. The front end section comprises in particular the fastening points to the drive battery or to the rear-axle support.

Ground clearance of the motor vehicle is consequently less affected by the fastening point, for example in the form of a screwed connection.

A rear end section of the torsion struts can have a closed hollow profile.

As a result, the torsion struts can be designed as stiffer and lighter in this region.

The rear drive battery fastening region can take the form of a casting, in particular an aluminum casting or steel casting, or a forged part.

The casting or forged part can here have an improved function in terms of collisions and stiffness and reduces the weight and the required structural space.

The abovementioned features could, where possible and appropriate, be combined with one another as desired.

A brief description of the figures follows.

### BRIEF DESCRIPTION OF THE DRAWINGS

FIG. 1 is a view in partial section of a subsection of a motor vehicle according to an exemplary embodiment of the present invention.

FIG. 2 is a plan view from below of a rear part of the motor vehicle.

### DETAILED DESCRIPTION OF THE DRAWINGS

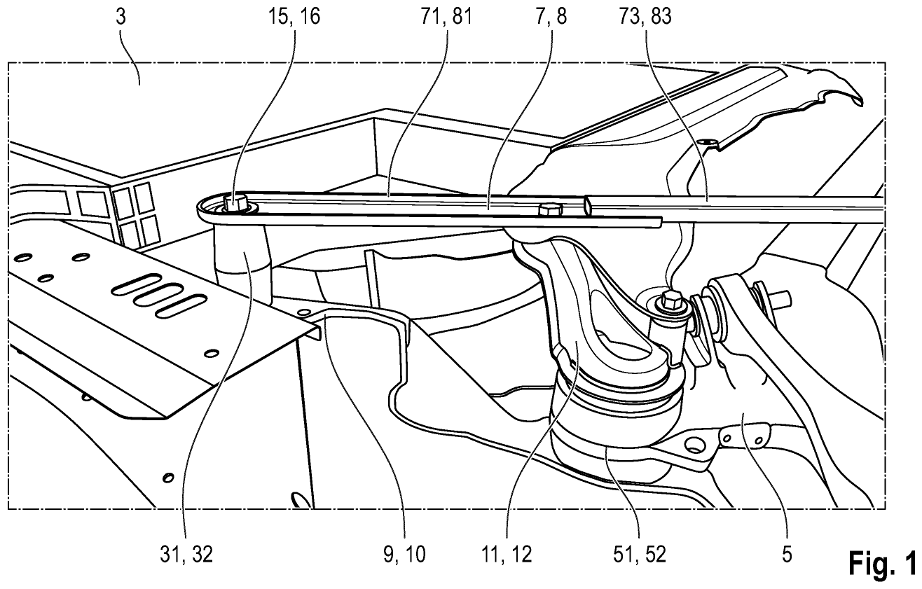

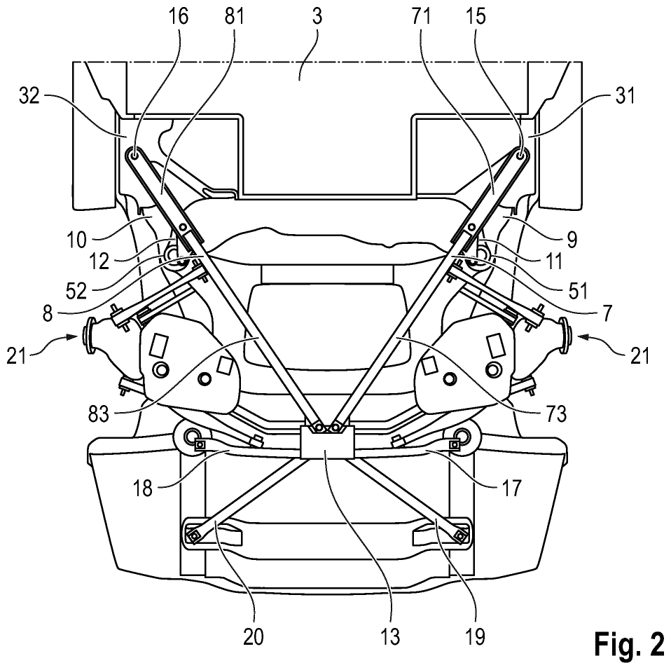

An exemplary embodiment of the present invention is explained below with reference to FIGS. 1 and 2. An electrically operated motor vehicle, in particular a passenger car, has a drive battery 3 which is arranged in a region of an underbody of the motor vehicle below a passenger compartment between a front axle, a rear axle, and two side sills. The drive battery is assembled on a body of the motor vehicle from below. A rear region including the whole rear end of the motor vehicle is shown in FIG. 2 in a plan view from below. Just a rear part of the drive battery 3 with its rear drive battery fastening regions 31 and 32 is shown. Moreover, a rear axle 21 with a rear-axle support 5 is shown. A strut assembly for stiffening the rear end is situated below the rear axle 21 and the rear-axle support 5. The strut assembly has, inter alia, a left torsion strut 7 and a right torsion strut 8 which run toward each other from front to back in a V-shape and meet in a region below and behind the rear axle 21 and are connected to each other via a bracket or a connecting element 13.

The left torsion strut 7 and the right torsion strut 8 are connected to the drive battery fastening region 31 and 32 at the front in the driving direction.

As can moreover be seen from the view in section of FIG. 1, the left torsion strut 7 is assembled on a left rear side member 9 of the body via a single screw 15 together with the left drive battery fastening region 31. Similarly, the right torsion strut 8 is assembled on a right rear side member 10 of the body via a single screw 16 together with the right drive battery fastening region 32. The left and the right rear side members 9, 10 are designed according to the exemplary embodiment as castings but could also take the form of sheet-metal shells.

The drive battery fastening regions 31, 32 are forged parts or castings with corresponding through holes/bores for the screwed connection at rear corners of the drive battery 3. The drive battery fastening regions 31, 32 are a fixed constituent part of the drive battery or a drive battery housing.

As shown in FIG. 1, the torsion struts 7, 8 are moreover connected indirectly to a left body fastening section 51 and a right body fastening section 52 of the rear-axle support 5. The body fastening sections 51, 52 are in turn connected to the left rear side member 9 and the right rear side member 10. In particular, the left torsion strut 7 is connected, i.e. screwed, to the left body fastening section 51 via a left additional support element 11 which acts essentially as a compression strut, and the right torsion strut 8 is connected, i.e. screwed, to the right body fastening section 52 of the rear axle support 5 via a right additional support element 12 which acts essentially as a compression strut. The additional support elements 11, 12 take the form of sheet-metal shells.

The torsion struts 7, 8 take the form of a profiled piece of sheet metal with an open profile at their front end section 71, 81, i.e. the section which is connected to the drive battery 3 and the drive battery fastening region 31, 32 and the additional support element 11 and 12. As a result, a structural height of the torsion struts 7, 8 is reduced in particular in the region of the screwed connections 15, 16, which has a positive effect on the ground clearance of the motor vehicle. In a rear section 73, 83, the torsion struts 7, 8 consist of a hollow profile which is connected to the profiled piece of sheet metal in a suitable firmly bonded fashion by, for example, welding or adhesive bonding. The connections of the front end sections 71 and 81 and the rear end sections 73 and 83 are situated behind the connection to the additional support element.

The strut assembly also has further struts, as shown in FIG. 2, which are likewise connected to the bracket and the connecting element 13. Central torsion struts 17, 18 which run essentially in the transverse direction (y direction) of the vehicle are connected in each case to a rear body fastening section of the rear axle support 5. Rear torsion struts 19, 20 are arranged in a V-shape in the reverse direction compared with the front torsion struts 7, 8 and are connected to rear sections of the left rear side member 9 and the right rear side member 10.

Overall, a sufficiently stiff rear end results according to the exemplary embodiment which is simplified in terms of manufacture and construction because the front torsion struts 7, 8 are screwed, jointly with the drive battery 3, via in each case a single screwed connection 15, 16 to the body, i.e. the rear side members 9, 10.

1.-8. (canceled)

9. An electrically operated motor vehicle, comprising:
a drive battery in a region of an underbody of the motor vehicle;
left and right torsion struts,
wherein the drive battery is assembled at a rear drive battery fastening region together with the left torsion strut and the right torsion strut on a left rear side member and a right rear side member, respectively, via, in each case, a single screwed connection.

10. The electrically operated motor vehicle according to claim 9, wherein
the left torsion strut and the right torsion strut are connected, in each case, to a rear-axle support.

11. The electrically operated motor vehicle according to claim 10, wherein
the left torsion strut and the right torsion strut are connected indirectly or directly to a left, front, body fastening section and a right, front, body fastening section, of the rear-axle support.

12. The electrically operated motor vehicle according to claim 11, wherein
the left torsion strut and the right torsion strut are connected to the respective body fastening section of the rear-axle support via a left additional support element and a right additional support element, respectively.

13. The electrically operated motor vehicle according to claim 10, wherein
the left torsion strut and the right torsion strut run rearward toward each other, in a V-shape, and are connected to each other in a region below the rear axle support.

14. The electrically operated motor vehicle according to claim 9, wherein
the rear drive battery fastening region is an aluminum casting, a steel casting, or a forged part.

15. The electrically operated motor vehicle according to claim 9, wherein
the left and right torsion struts comprise an open profile comprising a single-shell profiled piece of sheet metal or an extruded profile.

16. The electrically operated motor vehicle according to claim 15, wherein
the left and right torsion struts comprise a closed hollow profile comprising a two-shell piece of sheet metal or an extruded profile.

17. The electrically operated motor vehicle according to claim 16, wherein
a front section of the left and right torsion struts has the open profile and a rear section of the left and right torsion struts has the closed hollow profile.

18. The electrically operated motor vehicle according to claim 9, wherein
the left and right torsion struts comprise a closed hollow profile comprising a two-shell piece of sheet metal or an extruded profile.
